(19) United States
(12) Patent Application Publication
(10) Pub. No.: US 2007/0257845 A1
(43) Pub. Date: Nov. 8, 2007

(54) Compact Polarization-Sensitive and Phase-Sensitive Antenna With Directionality and Multi-Frequency Resonances

(75) Inventor: Alfred Y. Wong, Panorama City, CA (US)

Correspondence Address: NOVAK DRUCE DELUCA & QUIGG, LLP, 1300 EYE STREET NW, SUITE 1000 WEST TOWER, WASHINGTON, DC, 20005, US

(73) Assignee: NONLINEAR ION DYNAMICS, LLC, Panorama City, CA (US)

(21) Appl. No.: 11/696,040

(22) Filed: Apr. 3, 2007

Related U.S. Application Data
(60) Provisional application No. 60/744,142, filed on Apr. 3, 2006.

(51) Int. Cl. H01Q 1/38; H01Q 1/24

(52) U.S. Cl. 343/700 MS; 343/702

(57) ABSTRACT

A modulation system that can be used alone or in conjunction with current modulation techniques for data transmission in portable phones. The system consists of two orthogonal antennas of opposite polarization in which signals can be individually received and processed. A phase delay signal combination system allows combining the signals received on the two paths to allow selective reception of various polarizations. The rate of change between these two antennas will be different for each data signal, allowing a large increase in the number of users.

### CROSS-REFERENCE TO RELATED APPLICATION AND CLAIM FOR PRIORITY

This application claims priority under 35 U.S.C. §119(e) from copending Provisional Application Ser. No. 60/744,142 filed on Apr. 3, 2006.

### BACKGROUND OF THE INVENTION

1. Field of the Invention

The present invention relates to the field of antennae for communication, and in particular relates to an integrated antenna design for portable wireless communication devices, which has the built-in capability of increasing the number of users and expanding data transmission by creating new dimensions in coding. Antenna configurations are made compact by specially developed materials of high dielectric constants for this purpose.

2. Description of Prior Art

As the wireless world expands and portable communication devices such as cell phones, Personal Digital Assistants (PDAs), wireless e-mail devices, etc. become increasingly popular, the industry's focus is toward more efficient ways to add users to the saturated frequency spectrum. Many techniques have been developed to increase cellular capacity by separating signals in frequency and time domain.

Modulation schemes transfer data onto a carrier frequency where it is transmitted to a user who then must demodulate the received signal to acquire the data. The popular spread spectrum modulation ensures a secure form of data transfer with systems such as CDMA, Frequency-Hop MPSK, QPSK, etc.

Current forms of modulation are independent of the type of antenna used. Furthermore, most cell phone antennas are comprised of a simple monopole, which is linearly polarized in the vertical direction. Of the modulation schemes used in cell phone technology today, none incorporate the use of antenna polarization as a parameter in data transfer coding. The present invention advances the concept of two orthogonal antennae in a portable communication device to achieve a new dimension of coding.

### SUMMARY OF THE INVENTION

Two orthogonally polarized antennas and two isolated transceivers along with a selective mixing mechanism will provide a rate of change of polarization. This rate of change of polarization will define a system of data modulation that can be used alone or in conjunction with current forms of modulation as they are used in portable phone technology today.

### BRIEF DESCRIPTION OF THE DRAWINGS

FIG. 1 shows how two antennas are fed into two transceivers whose outputs are determined by a processing chip.

FIG. 2 shows two antenna outputs combined through a balun to yield one output fed into a transceiver.

FIG. 3 shows a compact flat antenna having two orthogonal input leads.

FIG. 4 shows an example of a patch antenna with a single input lead.

FIG. 5 is a graph showing characteristics of a patch antenna according to the invention.

FIG. 6 shows a pictorial example of the electric field distribution of the antenna in three dimensions.

FIG. 7 shows a radiation pattern simulation for the addition of the new dimension and the potential of utilization with all existing modulation techniques.

FIG. 8 shows a prototype installed inside a cordless phone showing the use of circuit board with one input lead. The concept can be generalized to a circuit board with orthogonal input leads.

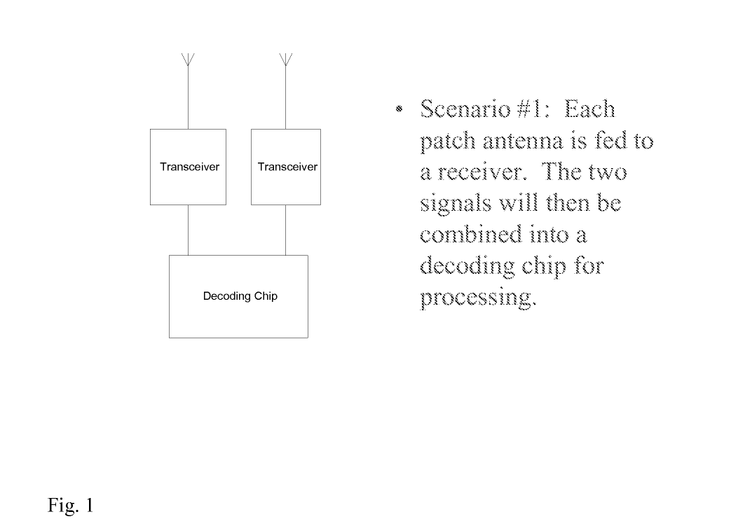

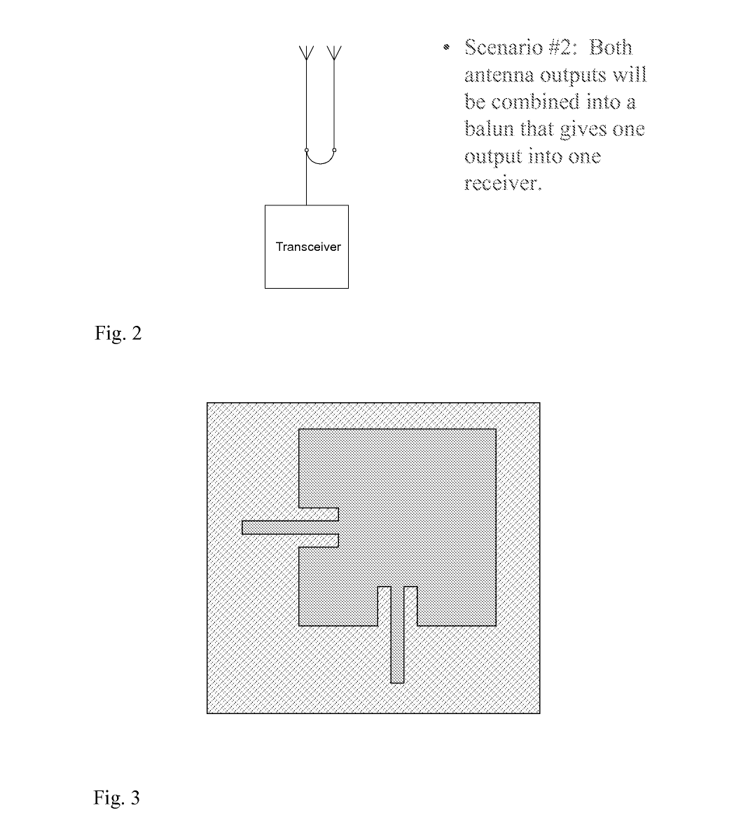

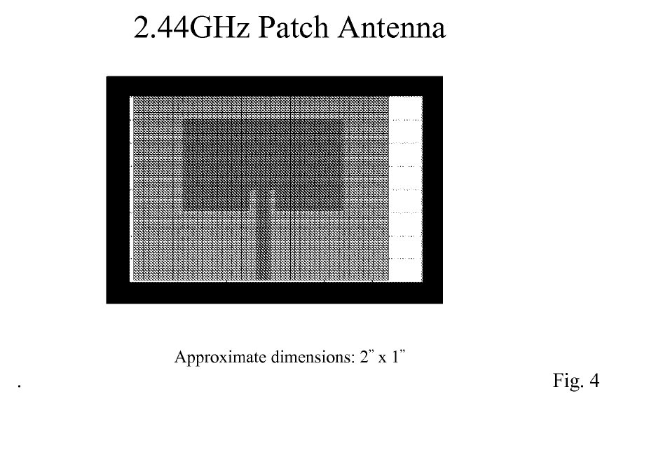

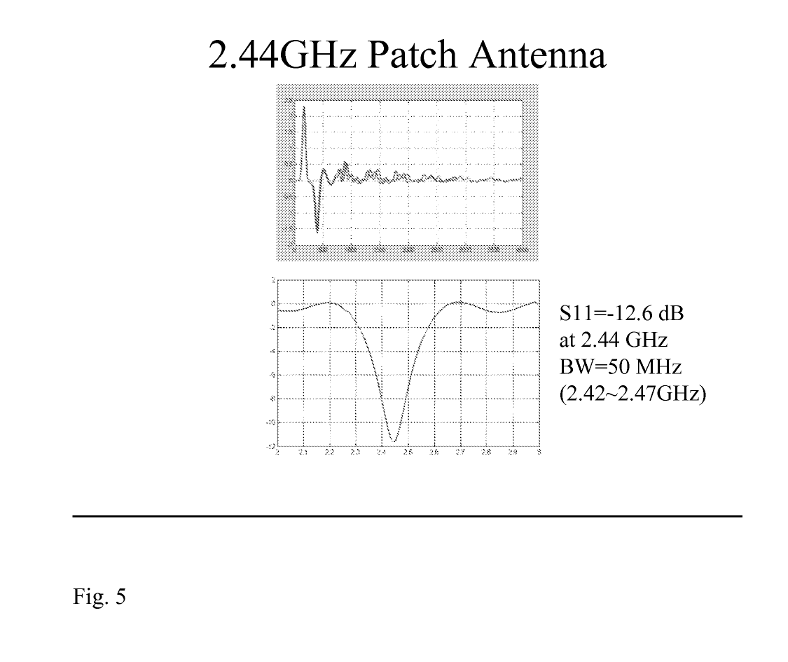

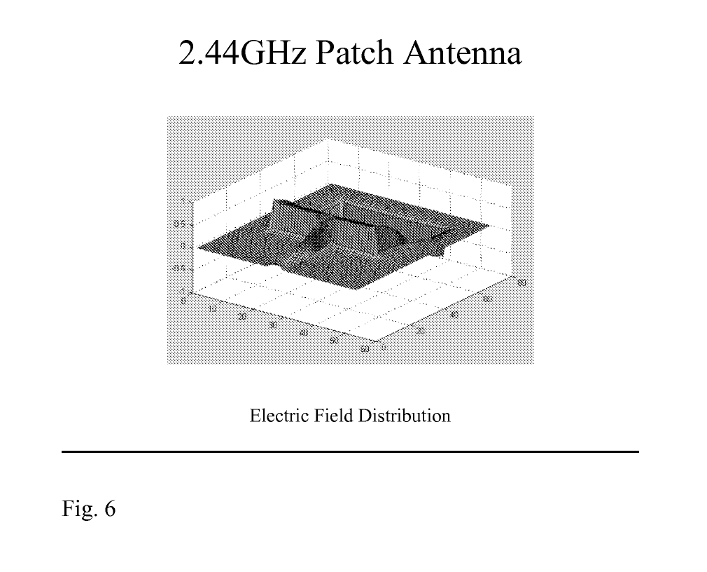

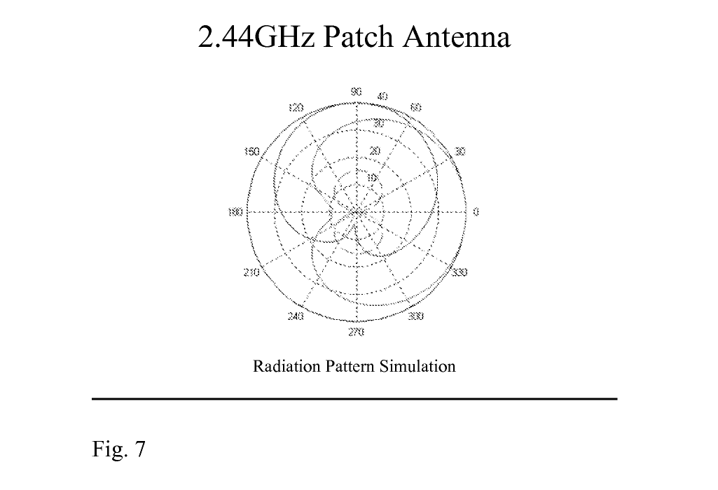

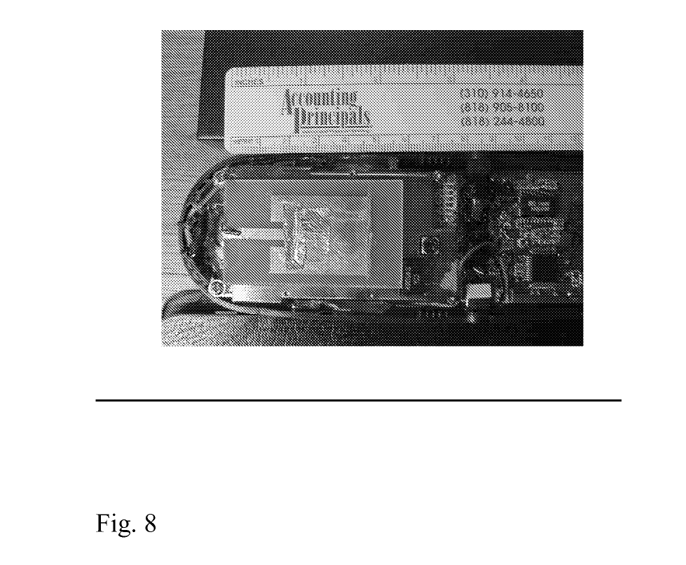

### DETAILED DESCRIPTION OF THE PREFERRED EMBODIMENTS

The two antennas are oriented such that one antenna is orthogonal to the other. In this position, one antenna will receive vertical linear polarization, while the other antenna will receive horizontal linear polarization. This creates two distinct modes of operation. If each antenna has a separate receiver, individual signals are received from each antenna. When a vertically polarized signal is transmitted, the vertically polarized antenna will receive this signal. Because of the reflection from buildings and other large objects in urban areas, the horizontally oriented antenna may receive a small portion of the original signal. However, because each antenna has separate circuitry, the vertical polarization can be chosen and the horizontally polarization ignored, and vice versa.

An equivalent method in describing the polarizations can also be to consider the two circular polarizations, i.e., instead of vertical and horizontal polarizations, right-hand circularly polarized and left-hand circularly polarized signals can be discriminated.

After amplification, the signals from both antennas can be combined with a controlled phase delay. This allows the selection of the component with a specific rate of change of polarization. The rate of change between linear and vertical polarization will define a new dimension of coding. Numerous users can transmit on the same frequency with the same coding scheme in the frequency domain, and the rate of change of polarization will define the individual signals. This modulation scheme will increase the current technologies by a factor of N, where N is limited only by the switching speed, signal stability, and scattering conditions.

Emphasis is placed on the rate of change of polarization as an important element in the proposed scheme. While metallic media can scatter an incident electromagnetic wave and hence its polarization, the rate of change between these polarizations cannot be changed by the metallic medium.

This new configuration requires two antennas, two transceivers, and an RF combiner to distinguish between the two polarizations. The cell base station can easily be made compatible as it currently uses two orthogonal antennas.

The invention having been disclosed, it will be apparent to those skilled in the art that the same may be varied in many ways without departing from the spirit and scope of the invention. Any and all such modifications are intended to be included in the scope of the following claims.

1. A portable communication device comprising:
two radio frequency transmitters;
two radio frequency receivers which can be combined with the transmitters;
two radio frequency antennas coupled to the two transmitters; and
a combiner which receives input signals from said receivers and detects changes in polarization of said input signals.

2. The portable communication device of claim 1, wherein said two antennas 1 are oriented with respect to each other by approximately 90 degrees.

3. The portable communication device of claim 1, wherein each antenna is tied to a processor which controls the phase of received and transmitted signals.

4. The portable communication device of claim 3, wherein said phase is controlled with respect to an internal frequency standard whose accuracy is maintained by an external world-wide transmission.

5. A communication signal coding scheme which combines changes in signal wave polarization with an existing coding scheme using at least one of a frequency, time, or space encoding parameter;
wherein a rate of polarization change is added to said existing coding scheme.

6. The portable communication device of claim 1, further comprising a non-planar metallic shield spaced apart from said antennas so as to be disposed between said antennas and a user of the portable communication device.

7. The portable communication device of claim 6, wherein the non-planar metallic shield is spaced apart from said antennas by a distance approximately equal to ¼ of an effective wavelength in a dielectric material of an operating frequency of the transmitter.

8. The portable communication device of claim 7, wherein said dielectric material has a dielectric constant greater than or equal to 50 and low loss characteristics such that the distance of ¼ effective wavelength can be achieved.

9. A portable communication device comprising:
two radio frequency transmitters;
two radio frequency antennas coupled to the two transmitters;
two radio frequency receivers which can be combined with the transmitters; and
a combiner which detects changes in the polarization and the rate of change of polarization of input signals from said transmitters and/or receivers; said antenna having a plurality of spaced-apart substantially planar arrays of radiating elements.

10. The portable communication device of claim 9 wherein the plurality of arrays are spaced apart by a distance approximately equal to ½ of an effective wavelength; each array consists of cross-dipoles which are orthogonal to each other.

11. The portable communication device of claim 10, further comprising means for controlling the phase and amplitude of the radiating elements.

12. The portable communication device of claim 11 wherein the means for controlling phase and amplitude includes means for scanning a receive and transmit pattern of the antenna while the polarization is switched at a predetermined rate.

13. The portable communication device of claim 12, wherein said tranmsit and receive antenna pattern can be different because of the transmit beam can be directional while the received beam can be omnidirectional.

14. A base station of a communication system, said base station being responsive to polarization changes in received communication signal waves and transmitting signals to mobile stations of said communication system with predetermined rates of wave polarization change.
